(19) United States
(12) Patent Application Publication
(10) Pub. No.: US 2008/0145274 A1
(43) Pub. Date: Jun. 19, 2008

(54) Porous Metering Device

(76) Inventor: Sasan Habibi-Naini, Rikon (CH)

Correspondence Address: Francis C. Hand, Esq., c/o Carella, Byrne, Bain,;Gilfillan, Cecchi, Stewart & Olstein, 5 Becker Farm Road, Rayseland, NJ, 07068, US

(21) Appl. No.: 11/998,480

(22) Filed: Nov. 30, 2007

(30) Foreign Application Priority Data
Dec. 14, 2006 (EP) 06126095.6

(51) Int. Cl. G01N 15/00

(52) U.S. Cl. 422/68.1

(57) ABSTRACT

The metering device includes a base having a first surface which borders on an infeed passage for a gaseous or fluid medium, a second surface which borders on a passage through which a viscous or pasty mass flows, and a recess communicating the two surfaces. The metering device also has a metering element which is made of a fluid-permeable or gas-permeable material that mates at least partly into the recess in the base. The metering element forms a fluid-conducting element having hollow spaces which form pores. The surface of the metering element facing the flow of viscous or pasty mass includes a coating by which the relevant pore diameter can be reduced such that an entry of the viscous or pasty mass into the interior of the metering element can be avoided.

This invention relates to a porous metering device. More particularly, this invention relates to a porous metering device including a metering member for the metering of fluids, in particular gases, to a fluid, viscous or pasty mass.

A porous sleeve is known from the prior art which can be used for the metering of a foaming agent into a polymer melt. In a metering device of this type, such as is shown, for example, in DE 101 50 329 A1, the introduction of a physical foaming agent, in particular, a gaseous foaming agent, possibly in an over-critical state, can take place via a cylinder which consists of a porous material and which is installed between a plasticising cylinder and a shut-off nozzle of an injection molding device. A static mixing element is arranged in the interior of the porous cylinder and has webs which extend into the melt passage and which provide a rearrangement of the melt and a mixing of the initially still inhomogeneous polymer/foaming agent system during the injection phase.

The use of the porous cylinder shown in DE 101 50 329 A1, which is held in a bore of a pressure chamber by means of the shut-off nozzle, is problematic in high pressure processes since the porous cylinder does not have sufficient pressure resistance. Accordingly, as suggested in application EP 06 119 392, whose content is herewith incorporated by reference, the metering device is not configured as a porous sleeve, but rather metering elements of a porous material are inserted into a sleeve which is, in particular, made as a high-tensile material.

A metering device which is particularly configured in accordance with EP 06 119 392 is suitable for use in high-pressure processes since, on the one hand, the weakening of the sleeve is limited to the surface of the metering elements. The metering elements of porous material naturally only have a limited strength. If, however, the surface portion of the metering elements does not exceed a maximum value of 25%, in particular of 20%, or in mixing work at high pressures in a particularly preferred manner 15%, the weakening does not result in the formation of hair-line cracks or comparable failure phenomena due to the notch effect of the metering elements. The smaller the surface portion of the metering elements at the surface of the sleeve, the higher the operating pressure or the maximum pressure difference can be selected between the inner surface of the sleeve and the outer surface of the sleeve.

It has, however, been found that for metering fluids, in particular gases, to a fluid, viscous or pasty mass at a mean pore diameter of approximately 10 μm and operating pressures around 1000 bar, the fluid, viscous or pasty mass can penetrate into the interior of the pores of the sleeve despite the counter-pressure of the additive to be introduced via the pores of the metering elements.

The fluid, viscous, pasty or gooey mass deposited in the interior of the pores has the tendency to successively clog the pores, whereby the function of the metering element is only maintained in a limited manner and the metering element ultimately becomes unusable. In particular, when a change in the composition of the fluid, viscous or pasty mass flowing on a surface of the metering element takes place, deposits of this type can have a disturbing effect. The deposits can namely enter into the fluid, viscous or pasty mass in an uncontrolled manner again on the charging of the metering element with a pressurised additive, whereby contamination of the mass can occur.

A further disadvantage results on the processing of masses whose dwell time in the metering device may not exceed a specific duration. If residues of masses of this type remain in the pores, unwanted reactions in the mass can occur, whereby a subsequently flowing mass is contaminated in the marginal region due to the extended dwell time.

With some gaseous or highly volatile additives, it has been found that the hollow spaces or pores of a metering element are contaminated in a region close to the surfaces by the gooey, viscous or pasty mass into which the additive which flows through the pores of the metering element should be introduced. As a consequence, the pores or hollow spaces clog close to these surfaces. The closure of the pores taking place by the clogging is either irreversible or is partly reversible, which has the consequence, however, that lumps of the mass periodically release from the hollow spaces or pores again and are again carried into the main flow of the gooey, viscous or pasty mass. This entry need not be critical, if the properties of the gooey, viscous or pasty mass do not change or do not substantially change due to the increased dwell time, but will result in considerable quality losses of the product mixed with the additive in masses which have a composition highly dependent on the dwell time or are even subject to chemical reactions dependent on the dwell time. Such quality losses will not allow a further processing of the gooey, viscous or pasty mass mixed with the additive under certain circumstances.

The entry of gooey, viscous or pasty mass into the inner spaces of the hollow spaces or pores should therefore be avoided completely where possible.

Accordingly, it is an object of the invention to be able to prevent a mass from penetrating into and remaining in the pores of a porous metering element of a metering device.

Briefly, the invention provides a metering device that includes a base that separates a first passage for a flow of a fluid medium from an infeed passage for a flow of a fluid additive and that has a recess communicating the infeed passage with the first passage. The metering device also includes a metering element of a permeable material disposed in the recess of the base. The metering element has a first surface communicating with the infeed passage, a second surface communicating with the first passage, a jacket surface matingly received in the recess and a plurality of pores for passing the fluid additive from the infeed passage into the first passage.

In accordance with the invention, the metering device includes means for reducing the cross-section of the pores in the metering element at the second surface, measured parallel to the main flow direction of the fluid medium, to prevent entry of the fluid medium into the metering element. The cross-section through which flow takes place can be reduced by the means by at least 10%, preferably by at least 18%, in particular by at least 36%.

The fluid medium is characterised in being at least one of a viscous mass and a pasty mass and the pores in the metering element are mutually connected such that a fluid additive, i.e. a liquid or gaseous additive, can flow through them from the first surface to the second surface.

The pore diameter of the metering element at the second surface amounts to a maximum of 10 μm, preferably 2-3 μm, in particular 0.5 μm.

The base is made of a steel, in particular a steel of high strength and notch impact strength, since the steel has to withstand a pressure cycling when a pasty, viscous or gooey mass is be charged with an additive in the metering device.

The fluid-permeable or gas-permeable material includes a ceramic material or a metal which is optionally made as an alloy.

A metering element can be manufactured by a sintering process in which the ceramic or metal material consisting of particles starts to melt at the surface under the supply of heat energy and the surfaces of the particles are mutually connected in this manner. The selection of the material is generally directed to the chemical reactivity of the additive and of the medium as well as to the operating temperature to be expected. The pressure resistance of the metering device cannot be ensured by the metering element, but only by the base.

The means in particular includes a coating for which a metallic and/or ceramic coating material is preferably used. The same selection criteria generally apply to the coating as to the material of the metering element, with the additional restriction that an adhesion capability of the coating on the base material has to be ensured.

The coating can be applied to the fluid-permeable or gas-permeable material by means of a physical vapor deposition (PVD) process or an equivalent process, such as a thermal spray process. The use of the PVD process in particular has the advantage that only the region of the metering element close to the surface is coated. It is thus ensured that only the maximum pore diameters directly at the surface of the metering element are reduced, but not in the core region of the metering element.

With a reduction in the pore diameter at the surface of the metering element due to the coating, the increase in the pressure loss to be expected therefrom remains within the limits which are predetermined by the restriction effect of the cross-section reduction in the region close to the surface.

The coating may consist of a plurality of layers with, preferably, a CrN or a TiN coating being used. The different layers include a primer to ensure that the coating adheres permanently to the undercoat of the metering element. At least one further layer of a top coat is applied to this primer, whereby in particular the wear resistance can be increased.

A metering device in accordance with one of the preceding embodiments can be used for the introduction of an additive into a melt, in particular of a foaming agent into a polymer melt.

These and other objects and advantages of the invention will become more apparent taken in conjunction with the accompanying drawings wherein:

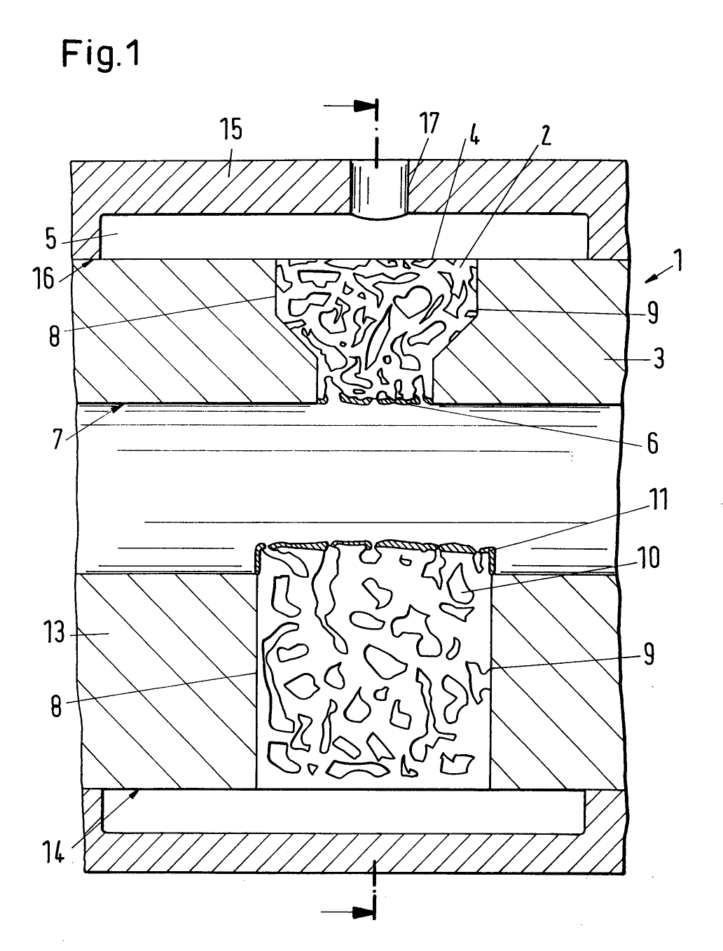

FIG. 1 illustrates a longitudinal section through a metering device in accordance with a first embodiment of the invention;

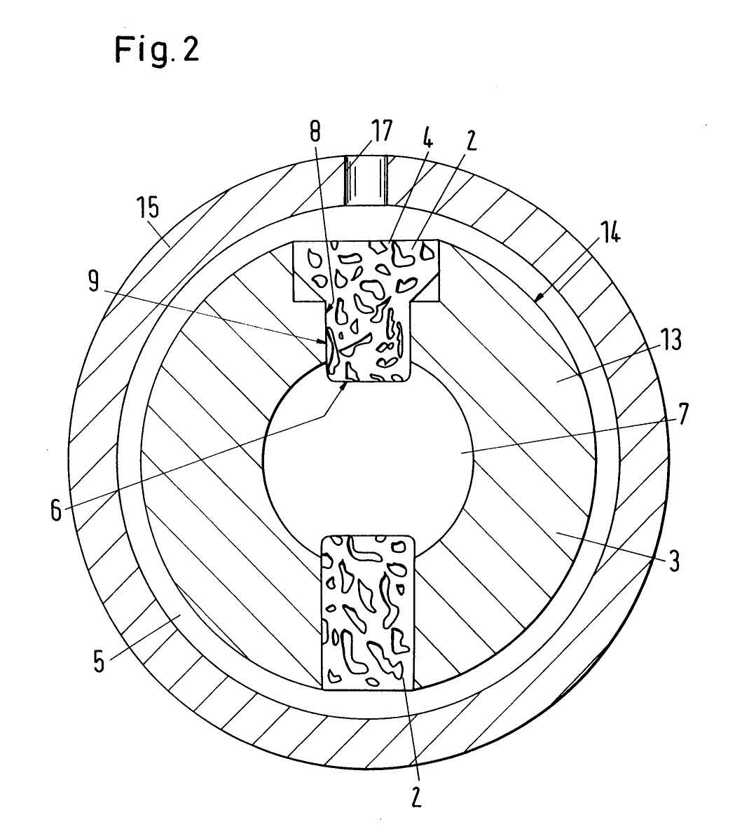

FIG. 2 illustrates a radial section through a modified metering device similar to FIG. 1 in accordance with the invention;

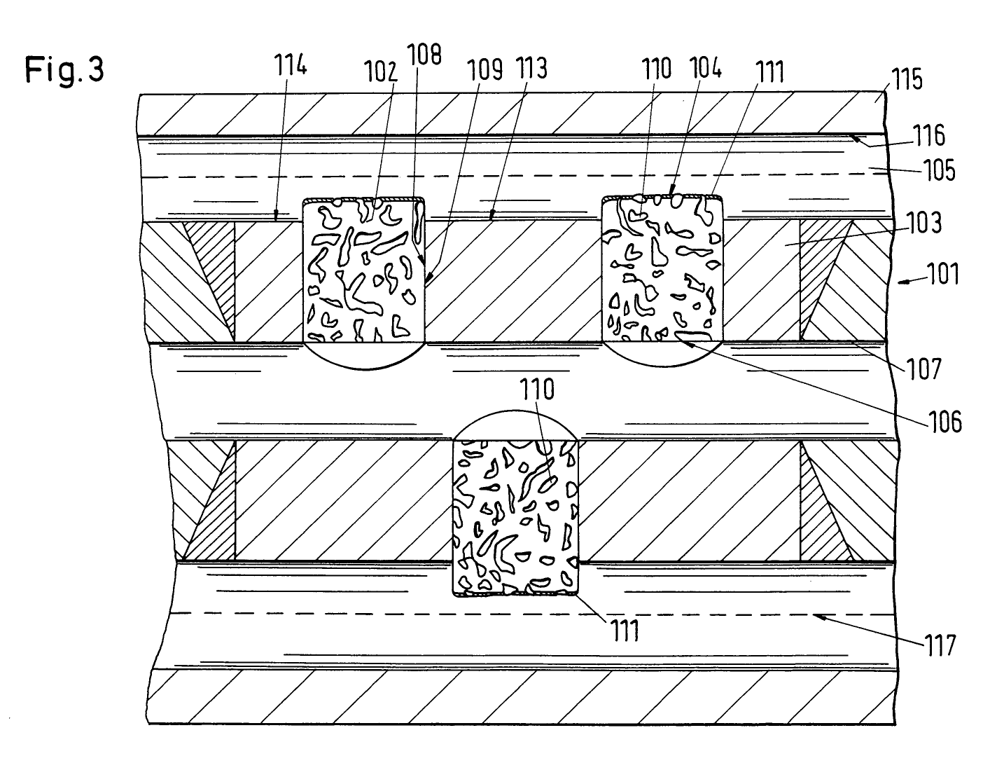

FIG. 3 illustrates a longitudinal section through a further embodiment of a metering device in accordance with the invention;

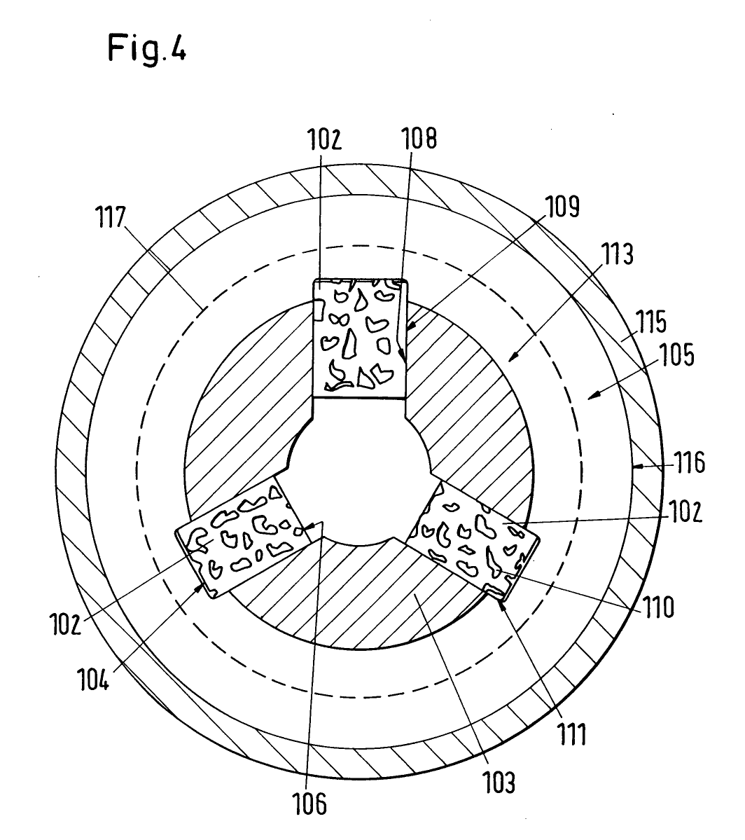

FIG. 4 illustrates a radial section through a modified metering device similar to FIG. 3;

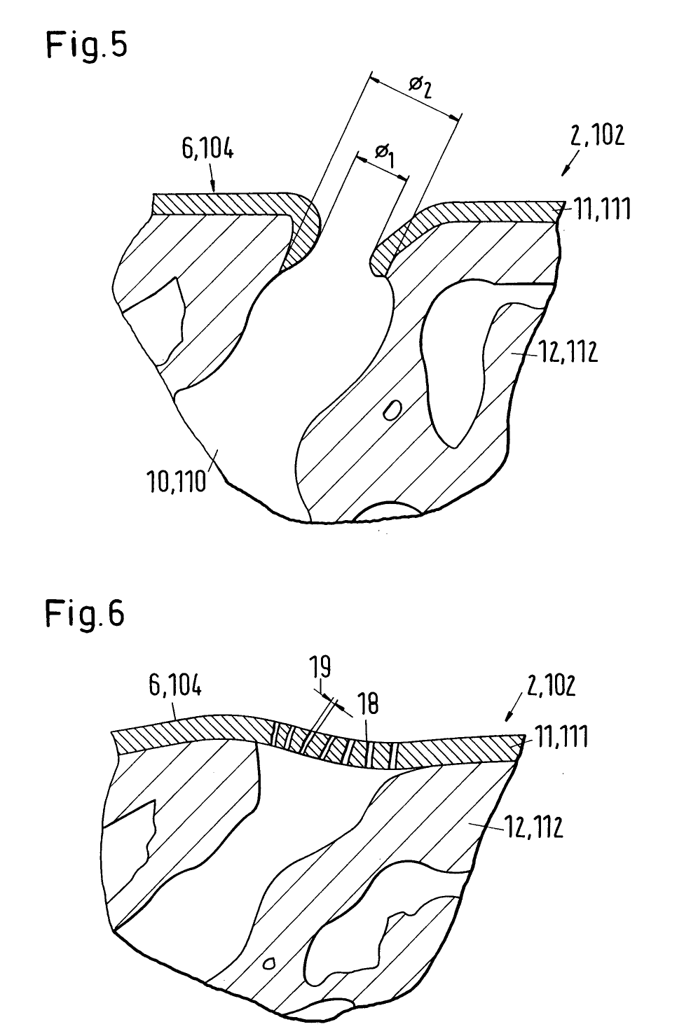

FIG. 5 illustrates an enlarged view through a section of a metering element in accordance with the invention; and

FIG. 6 illustrates an enlarged view through a section of modified metering element in accordance with the invention.

Referring to FIG. 1, a metering device 1 includes a metering element 2 made of a fluid-permeable or gas-permeable material that is embedded into a base 3 that includes a first surface 4, which borders on an infeed passage 5 for a gaseous or fluid medium, and a second surface 6, which borders on a passage section 7 through which a viscous or pasty mass flows. The metering element 2 and the base 3 thus together form a fluid-conducting element 13, with a metering means.

The first surface 4 and the second surface 6 of the metering element 2 of the fluid-conducting element 13 are substantially disposed opposite one another. In this embodiment, the fluid-conducting element 13 is in particular configured as a hollow cylinder in which a plurality of the aforesaid metering elements 2 are installed as the metering means. In this embodiment, an additive flows through the metering element 2, starting from its first surface 4 to the second surface 6.

The metering element 2 is fitted with a jacket surface 8 which extends between the first surface 4 and the second surface 6 and at least partly borders on a recess 9 of the base 3. The jacket surface 8 enters at least partly into a shape matched or force transmitting connection or a connection having material continuity with the metering element receiving recess 9 in the base 3 so that the metering element 2 can be fastened in the base material 3. That is to say, the metering element 2 mates within the recess 9 of the base 3.

A fluid-conducting element 13 of this type can thus be prefabricated completely with the metering elements 2 and is only installed on assembly in a shape matched or force transmitting manner or in a manner having material continuity, for example, subsequent to an extruder or upstream of an injection moulding machine.

The fluid-permeable and/or gas-permeable material of the metering element 2 has hollow spaces 10 forming pores that are mutually connected such that a gaseous or fluid medium can flow through them from the first surface 4 to the second surface 6.

The second surface 6 includes a coating 11 by which the relevant pore diameter, measured parallel to the main flow direction of the viscous or pasty mass, can be reduced such that an entry of the viscous or pasty mass into the interior of the metering element 2 can be avoided.

Referring to FIG. 2, wherein like reference characters indicate like parts as above, the metering device 1 includes a passage section 7 in which a fluid, viscous, gooey or pasty mass flows. The passage section 7 is bounded by a tube-shaped, fluid-conducting element 13 which includes a base 3 as well as at least one metering element 2. In the representation of FIG. 2, two metering elements 2 are arranged diametrically opposite one another. The lowermost metering element 2, as viewed, is shaped substantially cylindrically and the uppermost metering element 2, as viewed, has a cylindrical section and a conical section. Each metering element 2 is embedded in the base 3 and includes a first surface 4, which borders on an infeed passage 5 for a gaseous or fluid medium, and a second surface 6, which borders on the passage section 7 through which a viscous or pasty mass flows. The first surface 4 and the second surface 6 are disposed substantially opposite one another in this embodiment.

In this embodiment, an additive flows through each metering element 2, starting from the first surface 4, to the second surface 6.

The lowermost metering element 2, as shown, has a jacket surface 8 which extends between the first surface 4 and the second surface 6 and at least partly borders on a recess 9 of the base 3. The jacket surface 8 is at least partly connectable to the metering element receiving recess 9 in the base 3 by means of a shape matched or force transmitting connection or having material continuity so that the metering element 2 can be fixed in the base 3.

The infeed passage 5 for the additive can be made as an annular recess in the outer surface 14 of the base 3 substantially bordering on the first surface 4. Alternatively, or in combination therewith, as shown in FIG. 1, an annular jacket element 15 can be provided at whose inner surface 16 a recess can be provided. The additive thus flows in an infeed passage 5 which is configured as a ring passage, as is shown in FIG. 2, and from the infeed passage 5 via the first surface 4 through the metering elements 2 and enters into the passage section 7 at the second surface 6. A bore 17 is provided in the jacket element 15 a connection of an additive infeed.

The cylindrical section of the uppermost metering element 2 mates within a cylindrical section of the recess 9 of the base 3. As shown, the conical section of the metering element 2 has an uppermost cylindrical portion that mates within a second cylindrical section of the recess 9 and a lowermost conical portion that is spaced from the wall of the recess to form an annular gap of triangular shape.

Referring to FIG. 3, wherein like reference characters indicate like parts as above, the metering device 101 employs an annular passage 105 through which a fluid, flowable, viscous or pasty mass flows.

The annular passage 105 is surrounded by a concentric annular jacket element 115 whose inner surface 116 represents the outer interface for the flow. Due to the high viscosity of the mass, a substantially laminar flow is present in the annular passage 105 so that the flow speed increases continuously from this inner surface towards the center surface of the annular passage flow 117 as long as a deviating flow course with correspondingly deviating speed distributions is not enforced by installations.

The inner interface of the flow is substantially formed by the outer surface 114 of an annular base 103. The center surface 117 of the annular passage 105 is, in the case of a cylindrical outer surface 114 of the base 103, a cylinder with a radius which corresponds to half the radius of the inner surface 116 of the jacket element 115 plus half the radius of the outer surface 114 of the base 103.

Recesses 109 for the metering elements 102 are provided in the base 103 and each metering element is received in them in a shape matched or force transmitting manner (i.e. the metering element is force fit in said recess) or with material continuity. In particular, a force transmitting receiving of the metering element 102 in the associated recess 109 is shown in FIG. 3. An example for the production of a force transmitting connection of this type is the fitting of the (cold) metering element into the heated base material so that a press fit arises on the cooling of the base material and its contraction. In particular weld connections, solder connections or adhesive bond connections are used as connections with material continuity. An example for a shape matched connection is the installation of an at least partly conical metering element 102 into a corresponding conical mating shape of the recess 109. When conical metering elements are used, it is advantageous for the tip of the cone to face in the direction of the first surface 104 of the metering element so that the metering element is held in its recess 109 with an additional force by the pressure of the additive. If a metering element of this type is used, a nozzle effect results by the cross-section reducing in the direction of the first surface 104 so that the flow speed of the additive flowing through the metering element is increased.

An additive is supplied to the metering elements via a passage section 107 centrally within the base 103 and in communication with the metering elements 102. The additive enters into each metering element 102 from the additive-conducting element 113 via the second surface 106. The additive then flows through the pores or hollow spaces 110 of the metering element 102 and enters into the annular passage 105 through the first surface 104. Each metering element may project into the interior space of the annular passage 105 as shown so that a rearrangement of the flowing mass takes place through the metering element and a better mixing of the mass and of the additive can be carried out.

In order to avoid a fluid, viscous, gooey or pasty mass from moving into the pores or hollow spaces 110, in particular into a region close to the first surface 104, means, in the form of a coating 111 on at least a part of the first surface 104, is used to reduce the diameter of the pores or hollow spaces 110 in this region. The use of the coating 111 is explained in connection with FIG. 5.

Referring to FIG. 4, wherein like reference characters indicate like parts as above, three metering elements 102 are disposed in the base 103 in a circumferentially spaced apart array. Each metering element 102 is substantially shaped as a cylindrical body but may alternatively be configured conically or with cylindrical and conical sections.

Each metering element 102 is embedded into the base 103 and includes a first surface 104 which projects into the annular passage 105 through which a gooey, viscous or pasty mass flows and a second surface 106 which, unlike the embodiment of FIG. 3, which is recessed relative to the passage section 107 for the additive which may be any suitable gaseous or fluid medium. The first surface 104 and the second surface 106 are substantially opposite one another in this embodiment.

In this embodiment, the additive flows through each metering element 102, starting from the radially innermost second surface 106 to the radially outermost first surface 104.

Each metering element 102 has a jacket surface 108 which extends between the first surface 104 and the second surface 106 and at least partly borders on a recess 109 of the base 103. The jacket surface 108 is at least partly connectable to the metering element receiving recess 109 in the base material 103 by means of a shape matched or force transmitting connection or having material continuity so that the metering element 102 can be fastened in the base 103.

The arrangement of the metering elements is not restricted to the embodiments shown in FIG. 1 or FIG. 2 or to the embodiments shown in FIG. 3 or FIG. 4. Metering elements can in particular be arranged in the jacket element 115, with this jacket element then being sheathed by a further, outer jacket element, which is not shown in the Figs. In the jacket element 115 or in the outer jacket element, a recess for an infeed passage is provided which can, for example, be configured like the infeed passage 5 in FIG. 1.

Referring to FIG. 5, wherein like reference characters indicate like parts as above, the metering element (2, 102) includes a body (12, 112) consisting of a solid additive-resistant material. The forming of the hollow spaces or of the pores (10, 110) in the body (12, 112) of the metering element takes place either in a sintering process or in a stock-removal process such as an etching process, for example. Alternatively to this, the body can have a structure having a mixture of different types of materials. The hollow spaces are then obtained by washing out one of the materials which can be dissolved in a solvent. A structure then remains of one or more components of the structure which are not soluble in the solvent.

In the sintering process, the raw material is present as a powder and the particles of the powder begin to melt in the marginal zone whereby adjacent particles connect to one another. The intermediate spaces which have been present due to the spatial arrangement of the particles are at least partly maintained so that hollow spaces or pores are formed between the agglomerate formed from the particles which remain after the cooling of the agglomerate. An advantage of the sintering process is the possibility of processing the powder-like raw material into any desired shape designs so that the dimensions of the metering element can be selected as desired. The only restrictions consists of selecting the dimensions such that the heat input takes place substantially uniformly over the total volume of the metering element so that the region of the particles which has started to melt is substantially the same over the total volume of the metering element.

If, in contrast, an etching or washing out process is used for the manufacture of a porous metering element, the shaping of the metering element takes place in a method step disposed before the manufacture of the hollow spaces or pores.

The mean pore diameter of the pores 10,110 is reduced in a marginal region close to the surface 6,104 exposed to the passage in which the gooey, viscous or pasty mass flows. The flow speed of the highly volatile or gaseous additive with respect to the flow speed through the pores or hollow spaces of enlarged diameter is hereby increased in the marginal region of the metering element so that a backflow of gooey, viscous or pasty mass into the internal space of the hollow space is avoided.

The pore diameter in the region of the metering element close to the surface 6,104 amounts to a maximum of 10 μm, preferably 2-3 μm, in particular 0.5 μm.

The coating 11,111 that reduces the pore diameter includes at least one layer but can also consist of a plurality of layers of the same or of a different composition.

Referring to FIG. 6, wherein like reference characters indicate like parts as above, instead of using a coating, the means to reduce the pore diameter is in the form of a porous sleeve 11,111 that has smaller pores 18 than the body (12, 112). The sleeve is pulled over the metering element to cover the pores of the body 12,112 except for a cross-section 19 of the pores 18 through which flow takes place. The cross-section 19 through which flow takes place can thus be selected as desired to match the demands of the respective additive.

The use of a sleeve in particular facilitates handling in the case of contamination which affects the cross-section 19 through which flow takes place. In this case, the sleeve may be easily removed and replaced. This arrangement has the further advantage that the replacement of the sleeve takes up less time and the device for the introduction of an additive into a polymer melt can be put back in operation after a brief interruption. The sleeve can be liberated from contamination in a separate cleaning step.

To avoid contamination due to the fluid, viscous, gooey or pasty mass being deposited in the interior of the pores, the coating (11, 111) can also include a layer of dirt-repellent material, in particular a layer of a self-cleaning, nanocrystalline structure.

What is claimed is:

1. A metering device including
a base separating a first passage for a flow of a fluid medium characterised in having at least one of a viscous and pasty mass from an infeed passage for a flow of a fluid additive, said base having a recess communicating said infeed passage with said first passage;
a metering element of a permeable material disposed in said recess, said metering element having a first surface communicating with said infeed passage, a second surface communicating with said first passage, a jacket surface matingly received in said recess and a plurality of pores for passing the fluid additive from said infeed passage into said first passage; and
means for reducing the cross-section of said pores at said second surface to prevent entry of the fluid medium into said metering element.

2. A metering device in accordance with claim 1 wherein said pores at said second surface have a maximum diameter of 10 μm.

3. A metering device in accordance with claim 1 wherein said pores at said second surface have a maximum diameter of 2-3 μm.

4. A metering device in accordance with claim 1 wherein said pores at said second surface have a maximum diameter of 0.5 μm.

5. A metering device in accordance with claim 1 wherein said base is made of steel.

6. A metering device in accordance with claim 1 wherein said metering element is made of one of a ceramic material, a metal and a metal alloy.

7. A metering device in accordance with claim 1 wherein said means is a coating.

8. A metering device in accordance with claim 7 wherein said coating includes at least one layer of at least one of a metal and a ceramic coating material.

9. A metering device in accordance with claim 7 wherein said coating is characterised in being made by a PVD process.

10. A metering device in accordance with claim 7 wherein said coating includes a plurality of layers wherein at least one layer has a different composition from the other of said plurality of layers.

11. A metering device in accordance with claim 1 wherein said means reduces the cross-section of said pores by at least 10% to 36%.

12. A metering device in accordance with claim 1 wherein the fluid medium is a polymer melt and the additive is a foaming agent.

13. A metering device in accordance with claim 1 wherein said metering element is matingly disposed in said recess.

14. A metering device in accordance with claim 1 wherein said metering element is force fit in said recess.
